(19) United States
(12) Patent Application Publication
(10) Pub. No.: US 2021/0079673 A1
(43) Pub. Date: Mar. 18, 2021

(54) WATER-CONTAINING FLUID TRANSPORT PIPE AND TRANSPORT METHOD FOR WATER-CONTAINING FLUID

(71) Applicant: KAWABATA KOGYO CORPORATION, Fukui-shi, Fukui (JP)

(72) Inventor: Mitsuhiro NAKAMURA, Fukui-shi (JP)

(73) Assignee: KAWABATA KOGYO CORPORATION, Fukui-shi, Fukui (JP)

(21) Appl. No.: 16/966,599

(22) PCT Filed: Jan. 31, 2019
(86) PCT No.: PCT/JP2019/003501

§ 371 Date: Jul. 31, 2020

(30) Foreign Application Priority Data
Jan. 31, 2018 (JP) 2018-015450

(51) Int. Cl. E04G 21/04; F16L 9/147

(52) U.S. Cl. CPC E04G 21/04; F16L 9/147

(57) ABSTRACT

A water-containing fluid transport pipe and a water-containing fluid transport method, where, when transporting water-containing fluids, pipe clogging does not easily occur compared to conventional pipes that use general structural steel or the like; and quality degradation in the water-containing fluid caused by significant changes in the temperature of the pipe itself due to environmental effects can be suppressed. This water-containing fluid transporting pipe has an innermost layer formed on an inner surface thereof and containing a material that has a water absorption rate of at most 0.2 mass % and a thermal conductivity of at most 10 W/m·K. The water-containing fluid is fresh concrete, and the pipe is preferably a pressure-feeding pipe for fresh concrete. This water-containing fluid transport method includes a step for transporting a water-containing fluid inside said pipe. This concrete pouring method includes a step for pressure-feeding fresh concrete inside said pipe.

### TECHNICAL FIELD

The present invention relates to a pipe for transporting a water-containing fluid such as a pipe for pressure-feeding a fresh concrete and a method of transporting a water-containing fluid, and also relates to a method of placing concrete and a method of producing a fresh concrete set that includes series of fresh concretes which are pressure-fed for at least part of a period of time from the start of the pressure feeding until the finish of the pressure feeding.

### BACKGROUND ART

When fresh concrete is placed at the site of civil engineering or construction, the fresh concrete is charged from an agitator car (which is also referred to as a mixer car, a fresh concrete car, a truck mixer or the like) into a concrete pump car and is pressure-fed through a pipe such as a steel pipe to a placing site. At that time, when only the fresh concrete is pressure-fed, a cement part included in the fresh concrete is lowered in moving speed or is left on the surface of the pipe by friction on the surface of the pipe, with the result that a proportion of aggregates (such as gravel) in the fresh concrete is increased so as to easily cause a blockage within the pipe. This is caused by arching, that is, an arch-shaped lock which results from collision and friction of the aggregates within the pipe.

Conventionally, in order to prevent a pipe blockage caused by the pressure feeding of fresh concrete, it is general that a preceding material called a preceding mortar or a preliminary mortar is first charged into a concrete pump car and that the fresh concrete is then charged into the concrete pump car, thereby pressure-feeding the preceding mortar ahead of the fresh concrete. For example, Patent Document 1 discloses a method of pressure-feeding a preliminary mortar.
Patent Document 1: Japanese Unexamined Patent Application, Publication No. H08-1643

### DISCLOSURE OF THE INVENTION

### Problems to be Solved by the Invention

A preceding mortar is used in an amount of about 0.5 to 2 m³. This amount is low as compared with the loading capacity of a general agitator car. On the other hand, since the preceding mortar cannot be guaranteed (does not satisfy JIS standards) for strength which is required in fresh concrete to be placed, the preceding mortar is not allowed to be placed together with the fresh concrete. This causes a problem which will be described below.

Although a fresh concrete company needs to arrange a preceding mortar separately from fresh concrete, the amount of the preceding mortar is low as compared with the loading capacity of a general agitator car, and thus the operating rate of the agitator car is low. Since the preceding mortar is more inexpensive than the fresh concrete, the delivery of the preceding mortar results in a deficit. This may induce a consolidated delivery, that is, the delivery of the preceding mortar with the same agitator car as the fresh concrete. By the consolidated delivery, the fresh concrete mixed with the preceding mortar is generated. Placing such fresh concrete causes a result which does not satisfy the JIS standards as described above. In this way, the consolidated delivery is originally not allowed.

Since the amount of preceding mortar used of about 0.5 to 2 m³ is too large to be charged with a pipe, the preceding mortar is generally charged with a hopper. The fresh concrete is also charged with a hopper, and thus it is inevitable that the preceding mortar and the fresh concrete are easily mixed with each other. As described above, the fresh concrete mixed with the preceding mortar cannot be placed, and thus it is inevitably treated as an industrial waste. Although the used amount of preceding mortar is low as compared with the loading capacity of the agitator car, it is not low as an absolute amount, with the result that when such an amount of preceding mortar is used, a large amount of industrial waste is easily produced.

Although the preceding mortar after being used or the fresh concrete mixed with the preceding mortar is treated as industrial wastes, it cannot be discarded at the site, with the result that it is impossible to avoid a disadvantage in terms of cost and the risk of non-compliance.

Incidentally, in a conventionally pipe for pressure-feeding a fresh concrete using general structural steel or the like, the temperature thereof is remarkably easily changed by the influence of the environment. For example, in summer, the temperature of the pipe can often be significantly increased by solar radiation, whereas, in winter, the temperature of the pipe can often be significantly lowered by decreases in the temperatures of outside air, the ground and the like. In general, the properties of fresh concrete are changed by a temperature (for example, the outside temperature) which is equal to or less than 4° C. or equal to or greater than 35° C. Hence, when the pipe is exposed to a significant temperature change as described above, the fresh concrete which is pressure-fed within the pipe is also exposed to a significant temperature change, with the result that the quality thereof may be lowered.

As with fresh concrete, when a water-containing fluid (for example, a solid-liquid mixture such as a mortar, mud, or water-containing earth and sand, or an aqueous solution such as a reactive aqueous solution) is transported with general structural steel or the like, a pipe blockage may occur or the temperature of the pipe itself may be significantly changed by the influence of the environment so as to lower the quality of the water-containing fluid.

The present invention is made in view of the foregoing problems, and an object of the present invention is to provide a pipe for transporting a water-containing fluid and a method of transporting a water-containing fluid therewith in which firstly, when the water-containing fluid is transported, as compared with a conventional pipe using general structural steel or the like, a pipe blockage is unlikely to occur and in which secondly, it is possible to reduce a decrease in the quality of the water-containing fluid caused by a significant change in the temperature of the pipe itself resulting from the influence of the environment.

In particular, when the water-containing fluid is fresh concrete and the pipe is a pipe for pressure-feeding a fresh concrete, an object of the present invention is to provide a pipe for pressure-feeding a fresh concrete and a method of placing concrete therewith in which firstly, when a concrete inducer such as a preceding mortar is not used or the same amount thereof is used, the distance over which a fresh concrete can be pressure-fed without the occurrence of a pipe blockage can be increased as compared with the conventional pipe using general structural steel or the like or, when a fresh concrete is pressure-fed over a predetermined distance without the occurrence of a pipe blockage when the concrete inducer described above is used, the necessary amount of the concrete inducer described above can be reduced as compared with the conventional pipe and in which secondly, it is possible to reduce a decrease in the quality of the fresh concrete caused by a significant change in the temperature of the pipe itself resulting from the influence of the environment.

### Means for Solving the Problems

The present inventor has found that the foregoing problems can be solved by forming, on at least the inner surface of a pipe for transporting a water-containing fluid, an innermost layer which includes a material having a water absorption rate in a specific range and a thermal conductivity in a specific range, and thereby completes the present invention.

A pipe for transporting a water-containing fluid according to the present invention comprises an innermost layer formed on at least an inner surface of the pipe, the innermost layer including a material that has a water absorption rate of equal to or less than 0.2% by mass and a thermal conductivity of equal to or less than 10 W/m·K.

The material preferably has a notched Izod impact strength of equal to or greater than 100 J/m.

The material preferably has a volume wear rate of equal to or less than 85 when a volume wear rate of SS400 is set to 100.

The material preferably has a dynamic friction coefficient of equal to or less than 0.3.

The material is preferably a high density polyolefin having a viscosity average molecular weight of less than 1,000,000.

The high density polyolefin is preferably a high density ethylene-based polymer.

The material is preferably an ultra-high molecular weight polyolefin having a viscosity average molecular weight of equal to or greater than 1,000,000.

The ultra-high molecular weight polyolefin is preferably an ultra-high molecular weight ethylene-based polymer.

It is preferable that the pipe includes a flange fitting in at least one of both end portions of the pipe, and that a rough surface is formed in at least part of an interface between the pipe and the flange fitting.

It is preferable that the rough surface is formed with a screw-processed portion, and that the screw-processed portion is formed in each of the pipe and the flange fitting and the screw-processed portions engage with each other.

The water-containing fluid is preferably an aqueous solution or a water-containing solid-liquid mixture.

It is preferable that the water-containing fluid is a fresh concrete, and that the pipe is a pipe for pressure-feeding a fresh concrete.

A method of transporting a water-containing fluid according to the present invention comprises: transporting the water-containing fluid within the pipe for transporting a water-containing fluid according to the present invention.

A method of placing concrete according to the present invention comprises: pressure-feeding a fresh concrete within the pipe for pressure-feeding a fresh concrete according to the present invention.

A method of producing a fresh concrete set according to the present invention comprises: pressure-feeding a fresh concrete within the pipe for pressure-feeding a fresh concrete according to the present invention, wherein the fresh concrete set includes a series of fresh concretes which are pressure-fed for at least part of a period of time from start of the pressure feeding until finish of the pressure feeding.

A first method of connecting pipes for transporting a water-containing fluid according to the present invention comprises:

bringing, into close contact with each other, first and second pipes for transporting a water-containing fluid; a cutout portion being formed in a vicinity of at least one of end portions of the first or second pipe for transporting a water-containing fluid; the close contact being brought into at the end portions in the vicinity of which the cutout portions are formed; and then

fitting a joint so as to bridge between the cutout portion in the first pipe for transporting a water-containing fluid and the cutout portion in the second pipe for transporting a water-containing fluid, thereby fixing together the first and second pipes for transporting a water-containing fluid, wherein the first and second pipes for transporting a water-containing fluid are the pipe for transporting a water-containing fluid according to the present invention.

A second method of connecting pipes for transporting a water-containing fluid according to the present invention comprises:

fitting a first pipe for transporting a water-containing fluid and a first flange fitting to each other and fitting a second pipe for transporting a water-containing fluid and a second flange fitting to each other; then

bring a flange portion of the first flange fitting and a flange portion of the second flange fitting into close contact with each other; and then

fixing the first and second flange fittings with a joint so as to connect the first and second pipes for transporting a water-containing fluid,

wherein the first and second pipes for transporting a water-containing fluid are the pipe for transporting a water-containing fluid according to the present invention.

It is preferable in the fitting,

that the first pipe for transporting a water-containing fluid and the first flange fitting are fitted to each other by a method including fixing together the first pipe for transporting a water-containing fluid and the first flange fitting by engagement of screw-processed portions that are respectively formed in the first pipe for transporting a water-containing fluid and the first flange fitting so as to engage with each other, in at least part of a region where the first pipe for transporting a water-containing fluid and the first flange fitting are brought into contact with each other, and

that the second pipe for transporting a water-containing fluid and the second flange fitting are fitted to each other by a method including fixing together the second pipe for transporting a water-containing fluid and the second flange fitting by engagement of screw-processed portions that are respectively formed in the second pipe for transporting a water-containing fluid and the second flange fitting so as to engage with each other, in at least part of a region where the second pipe for transporting a water-containing fluid and the second flange fitting are brought into contact with each other.

It is preferable in the fitting,

that the first pipe for transporting a water-containing fluid and the first flange fitting are fitted to each other by a method including fixing together the first pipe for transporting a water-containing fluid and the first flange fitting in an overlapping part between the first pipe for transporting a water-containing fluid and the first flange fitting, the fixing being performed by screwing the first flange fitting and the first pipe for transporting a water-containing fluid together from outside toward inside the first pipe for transporting a water-containing fluid in a radial direction or by pinning the first flange fitting and the first pipe for transporting a water-containing fluid together with a pin inserted through a through hole that is formed to penetrate the first flange fitting and the first pipe for transporting a water-containing fluid from outside toward inside the first pipe for transporting a water-containing fluid in a radial direction, and

that the second pipe for transporting a water-containing fluid and the second flange fitting are fitted to each other by a method including fixing together the second pipe for transporting a water-containing fluid and the second flange fitting in an overlapping part between the second pipe for transporting a water-containing fluid and the second flange fitting, the fixing being performed by screwing the second flange fitting and the second pipe for transporting a water-containing fluid together from outside toward inside the second pipe for transporting a water-containing fluid in a radial direction or by pinning the second flange fitting and the second pipe for transporting a water-containing fluid together with a pin inserted through a through hole that is formed to penetrate the second flange fitting and the second pipe for transporting a water-containing fluid from outside toward inside the second pipe for transporting a water-containing fluid in a radial direction.

### Effects of the Invention

According to the present invention, it is possible to provide a pipe for transporting a water-containing fluid and a method of transporting a water-containing fluid therewith in which firstly, when the water-containing fluid is transported, as compared with a conventional pipe using general structural steel or the like, a pipe blockage is unlikely to occur and in which secondly, it is possible to reduce a decrease in the quality of the water-containing fluid caused by a significant change in the temperature of the pipe itself resulting from the influence of the environment. In particular, when the water-containing fluid is fresh concrete and the pipe is a pipe for pressure-feeding a fresh concrete, according to the present invention, it is possible to provide a pipe for pressure-feeding a fresh concrete and a method of placing concrete therewith in which firstly, when a concrete inducer such as a preceding mortar is not used or the same amount thereof is used, the distance over which a fresh concrete can be pressure-fed without the occurrence of a pipe blockage can be increased as compared with the conventional pipe using general structural steel or the like or, when a fresh concrete is pressure-fed over a predetermined distance without the occurrence of a pipe blockage when the concrete inducer described above is used, the necessary amount of the concrete inducer described above can be reduced as compared with the conventional pipe and in which secondly, it is possible to reduce a decrease in the quality of the fresh concrete caused by a significant change in the temperature of the pipe itself resulting from the influence of the environment.

### BRIEF DESCRIPTION OF THE DRAWINGS

FIG. 1 is a front view showing an example of the connecting part of the pipes for pressure-feeding a fresh concrete according to the present invention.

FIG. 2 is a front view showing another example of the connecting part of the pipes for pressure-feeding a fresh concrete according to the present invention.

FIGS. 3A to 3L are cross-sectional views showing the results of observations of a process in which the pipe for pressure-feeding a fresh concrete according to the present invention is worn.

FIG. 4A is a front view showing an example of the pipe for pressure-feeding a fresh concrete according to the present invention which includes flange fittings.

FIG. 4B is a side view showing the measurement positions of pipe wall thickness in a continuous pressure-feeding durability test on the pipe shown in FIG. 4A.

### PREFERRED MODE FOR CARRYING OUT THE INVENTION

### <Pipe for Transporting a Water-Containing Fluid, in Particular, a Pipe for Pressure-Feeding a Fresh Concrete>

A pipe for transporting a water-containing fluid according to the present invention comprises an innermost layer formed on at least an inner surface of the pipe, the innermost layer including a material that has a water absorption rate of equal to or less than 0.2% by mass and a thermal conductivity of equal to or less than 10 W/m·K. Examples of the water-containing fluid described above include aqueous solutions such as a reactive aqueous solution (for example, a corrosive aqueous solution) and solid-liquid mixtures such as fresh concrete, a mortar, mud and water-containing earth and sand. When the water-containing fluid is a fresh concrete, the pipe described above may be a pipe for pressure-feeding a fresh concrete.

Since the pipe comprises an innermost layer formed on at least an inner surface of the pipe, the innermost layer including the material stated above, firstly, a pipe blockage is unlikely to occur as compared with a conventional pipe using general structural steel or the like when the water-containing fluid is transported, and secondly, it is possible to reduce a decrease in the quality of the water-containing fluid caused by a significant change in the temperature of the pipe itself resulting from the influence of the environment. In particular, in the case where the water-containing fluid is a fresh concrete and the pipe is a pipe for pressure-feeding a fresh concrete, since the pipe comprises an innermost layer formed on at least the inner surface of the pipe, the innermost layer including the material described above, firstly, when a concrete inducer such as a preceding mortar is not used or the same amount thereof is used, the distance over which a fresh concrete can be pressure-fed without the occurrence of a pipe blockage can be increased as compared with the conventional pipe using general structural steel or the like or, when a fresh concrete is pressure-fed over a predetermined distance without the occurrence of a pipe blockage when the concrete inducer described above is used, the necessary amount of the concrete inducer described above can be reduced as compared with the conventional pipe, and secondly, it is possible to reduce a decrease in the quality of the fresh concrete caused by a significant change in the temperature of the pipe itself resulting from the influence of the environment. A method of producing the pipe described above is not particularly limited, and examples thereof include compression molding, compression molding and cutting subsequent thereto and the like. In the following description, the “distance over which the fresh concrete can be pressure-fed without the occurrence of a pipe blockage” is also referred to as the “pressure-feeding distance of the fresh concrete” or is also simply referred to as the “pressure-feeding distance”.

The layer configuration of the pipe described above is not particularly limited as long as the effects of the present invention are not impaired. For example, the entire pipe may be formed with an innermost layer which includes the material described above, the pipe may be formed with an innermost layer which includes the material described above and an outermost layer which does not include the material described above, or the pipe may be formed with an innermost layer which includes the material described above, one or more intermediate layers and an outermost layer and one of the intermediate layers in contact with the innermost layer may be a layer which does not include the material described above. When the intermediate layer or the outermost layer is a layer which does not include the material described above, the layer may be formed of general structural steel such as SS400.

The outside diameter and the inside diameter of the pipe described above are not particularly limited as long as the effects of the present invention are not impaired. The outside diameter may be, for example, 10 to 300 mm, 20 to 250 mm, or 50 to 170 mm. The inside diameter may be, for example, 5 to 250 mm, 10 to 200 mm, or 40 to 120 mm. However, the outside diameter is larger than the inside diameter.

The water absorption rate of the material described above is equal to or less than 0.2% by mass, and may be equal to or less than 0.1% by mass or equal to or less than 0.05% by mass. When the water absorption rate is equal to or less than 0.2% by mass, water in the water-containing fluid is unlikely to be absorbed in the pipe at the time of transport of the water-containing fluid, and the fluidity of the water-containing fluid is therefore unlikely to be lowered. Consequently, when the water-containing fluid is transported, a pipe blockage is unlikely to occur as compared with the conventional pipe using general structural steel or the like. In particular, in the case where the water-containing fluid is a fresh concrete and the pipe is a pipe for pressure-feeding a fresh concrete, if the water absorption rate is equal to or less than 0.2% by mass, water in the fresh concrete is unlikely to be absorbed in the pipe at the time of pressure feeding of the fresh concrete, and thus the fluidity of the fresh concrete is unlikely to be lowered. Consequently, when the concrete inducer such as the preceding mortar is not used, the pressure-feeding distance of the fresh concrete can be effectively increased as compared with a conventional pressure-feeding distance. When the concrete inducer is used, the pressure-feeding distance can be effectively increased with the same amount of the concrete inducer as compared with the conventional pressure-feeding distance, or the pressure-feeding distance equivalent to the conventional pressure-feeding distance can be effectively achieved with a smaller amount of the concrete inducer. In the present specification, the water absorption rate is measured according to JIS K 7209.

The thermal conductivity of the material described above is equal to or less than 10 W/m·K and may be equal to or less than 5 W/m·K or equal to or less than 1 W/m·K. Although the lower limit of the thermal conductivity is not particularly limited, in practice, for example, the thermal conductivity may be equal to or greater than 0.1 W/m·K, equal to or greater than 0.2 W/m·K, or equal to or greater than 0.3 W/m·K. When the thermal conductivity is equal to or less than 10 W/m·K, for example, even if in summer, the temperature of the outer surface of the pipe is increased to 50° C. or greater by solar radiation, the inside of the pipe is unlikely to reach a high temperature equal to or greater than 35° C.; whereas for example, even if in winter, the temperature of the outer surface of the pipe drops below freezing by decreases in the temperatures of outside air, the ground and the like, the inside of the pipe is unlikely to reach, for example, a low temperature equal to or less than 4° C. Consequently, the fresh concrete within the pipe is easily kept substantially at the same temperature as the outside temperature, and thus the water-containing fluid such as the fresh concrete is unlikely to be exposed to a high temperature or a low temperature, with the result that it is possible to effectively prevent the quality thereof from being lowered. In the present specification, the thermal conductivity is measured according to JIS A 1412-1.

The density of the material described above is not particularly limited, and may be, for example, equal to or less than 5 g/cm³, equal to or less than 4 g/cm³, or equal to or less than 3 g/cm³. Although the lower limit of the density is not particularly limited, in practice, the density may be, for example, equal to or greater than 0.5 g/cm³, equal to or greater than 0.7 g/cm³, or equal to or greater than 0.8 g/cm³. When the density is equal to or less than 5 g/cm³, the weight of the pipe is easily reduced, and thus the labor savings of the operation and the enhancement of workability can be effectively realized. When the pipe described above is installed in a vehicle such as a concrete pump car, the total weight of the vehicle is unlikely to be increased, and thus the weight of the vehicle is easily reduced.

The notched Izod impact strength of the material described above is not particularly limited, and may be, for example, equal to or greater than 100 J/m, equal to or greater than 120 J/m, or equal to or greater than 150 J/m. The pipe for transporting a water-containing fluid (for example, the pipe for pressure-feeding a fresh concrete), the pipe being formed of a material capable of being plastically deformed (for example, a metal), is easily plastically deformed when receiving an impact from outside or inside the pipe. In the plastically deformed pipe, a convex toward the inside or the outside of the pipe is easily produced at the plastically deformed site. When the water-containing fluid is transported within the pipe in which such a convex is produced, in particular, when the fresh concrete is pressure-fed therewithin, abnormal wear easily occurs in the convex part, with the result that at the worst case, the pipe may rupture. However, when the Izod impact strength is equal to or greater than 100 J/m, even if the pipe receives an impact in a certain range, the pipe is unlikely to be plastically deformed and behaves as an elastic member which is restored to its original shape, with the result that the pipe is excellent in impact resistance. In particular, when the impact resistance of the pipe is required, the Izod impact strength may be, for example, equal to or greater than 500 J/m or equal to or greater than 700 J/m, and furthermore, when the Izod impact strength is measured, a test piece formed of the material described above does not need to be destroyed. In the present specification, the notched Izod impact strength is measured according to JIS K 7110.

The volume wear rate of the material described above is not particularly limited, and for example, when the volume wear rate of SS400 is set to 100, the volume wear rate may be, for example, equal to or less than 85, equal to or less than 83, or equal to or less than 80. Although the lower limit of the volume wear rate is not particularly limited, in practice, for example, the volume wear rate described above may be equal to or greater than 5, equal to or greater than 7, or equal to or greater than 10 when the volume wear rate of SS400 is set to 100. The water-containing fluid may include a component which has a large frictional force, and thus the pipe for transporting a water-containing fluid may wear by making contact with such a component. In particular, when the water-containing fluid is a fresh concrete and the pipe is a pipe for pressure-feeding a fresh concrete, the fresh concrete includes an aggregate, and the aggregate has a large frictional force, with the result that the pipe for pressure-feeding a fresh concrete may wear by making contact with the aggregate.

However, when the volume wear rate is equal to or less than 85, the pipe has sufficient wear resistance, and thus the pipe is unlikely to wear at the time of transport of the water-containing fluid such as at the time of pressure feeding of the fresh concrete, with the result that the long life of the pipe is easily realized. In a case where the wear resistance of the pipe is particularly required, for example, the volume wear rate described above may be equal to or less than 40, equal to or less than 30, or equal to or less than 20 when the volume wear rate of SS400 is set to 100. In the present specification, the volume wear rate is calculated as follows. When a wear test is performed in which a test piece that has dimensions of 75 mm×25 mm×6.4 mm and that includes a circular through hole having a diameter of 11 mm in the center of a principal plane is rotated in sand slurry formed of 50% by mass of No. 5 silica sand (28 mesh) and 50% by mass of water at a rotation speed of 1750 rpm at a temperature of 30 to 35° C. for 7.5 hours around a rotation shaft perpendicular to the principal plane and passing through the center of the principal plane, a value is determined by being calculated with a formula of (the reduced amount of volume of the test piece before and after the wear test)/(the volume of the test piece before the wear test), the volume wear rate of SS400 determined in the same manner is set to 100, and the value described above is converted.

The dynamic friction coefficient of the material described above is not particularly limited, and may be, for example, equal to or less than 0.3, equal to or less than 0.25, or equal to or less than 0.2. Although the lower limit of the dynamic friction coefficient is not particularly limited, in practice, the dynamic friction coefficient may be, for example, equal to or greater than 0.05, equal to or greater than 0.07, or equal to or greater than 0.1. When the dynamic friction coefficient is equal to or less than 0.3, a frictional force produced between the wall surface of the pipe and the water-containing fluid such as the fresh concrete is easily reduced at the time of transport of the water-containing fluid such as at the time of pressure feeding of the fresh concrete, and shear stress which is applied to the water-containing fluid such as the fresh concrete is easily decreased. Consequently, a pipe blockage is unlikely to occur, and in particular, when the water-containing fluid is a fresh concrete and the pipe is a pipe for pressure-feeding a fresh concrete, the pressure feeding of the fresh concrete is easily performed without use of the concrete inducer such as the preceding mortar or with the amount of concrete inducer described above being reduced, and the pressure of the pressure feeding is easily lowered as compared with a conventional pressure. Hence, at the site of construction, industrial wastes caused by the use of the concrete inducer described above are easily reduced, and labor savings and the enhancement of safety when the fresh concrete is pressure-fed are easily achieved. In the present specification, the dynamic friction coefficient is measured according to A method in JIS K 7218 under conditions in which a circular test piece is used, a speed is 15 m/minute, a surface pressure is 2 MPa, a counterpart material is S45C, and no lubrication is performed.

The material described above may have self-lubrication unlike general structural steel or the like. Here, the self-lubrication refers to a property in which adhesion is unlikely to occur, for example, because the material has a layered crystal structure or the dynamic friction coefficient is low. The self-lubrication contributes to the smooth pressure feeding of the water-containing fluid such as the fresh concrete within the pipe at the time of transport of the water-containing fluid such as at the time of pressure feeding of the fresh concrete and to the realization of the transport of the water-containing fluid (in particular, when the water-containing fluid is the fresh concrete, the placing of the fresh concrete) without impairing the properties of the water-containing fluid being transported (for example, the fresh concrete being pressure-fed).

The material described above is not particularly limited as long as the water absorption rate thereof is equal to or less than 0.2% by mass and the thermal conductivity thereof is equal to or less than 10 W/m·K, and examples thereof include: polyolefins such as a high density polyolefin and an ultra-high molecular weight polyolefin; fluorine resins such as polytetrafluoroethylene (PTFE, Teflon (registered trademark)); polyarylene sulfides (PAS) such as a polyphenylene sulfide (PPS); aromatic polyether ketones such as a polyether ether ketone (PEEK); and polyesters such as a polyethylene terephthalate (PET). In terms of impact resistance, wear resistance, a lubrication property and the like, the material described above is preferably a high density polyolefin or an ultra-high molecular weight polyolefin.

Examples of the high density polyolefin include a high density ethylene-based polymer, and more specific examples include a high density polyethylene. The density of the high density polyolefin is equal to or greater than 0.942 g/cm³, and may be equal to or greater than 0.945 g/cm³ or equal to or greater than 0.948 g/cm³ in terms of impact resistance, wear resistance and the like. Although the upper limit of the density described above is not particularly limited, in practice, the density may be, for example, equal to or less than 0.97 g/cm³, equal to or less than 0.96 g/cm³, or equal to or less than 0.952 g/cm³. In terms of processability and the like, the viscosity average molecular weight of the high density polyolefin may be, for example, less than 1,000,000, equal to or less than 600,000, or equal to or less than 450,000. In terms of impact resistance, wear resistance and the like, the viscosity average molecular weight may be, for example, equal to or greater than 200,000, equal to or greater 300,000, or equal to or greater than 350,000. In the present specification, the viscosity average molecular weight is calculated from a limiting viscosity number [η] measured according to ISO 1628-3:2010 by a known conversion formula, for example, Mv=5.37×10⁴×[η]^{1.37} (where Mv represents the viscosity average molecular weight).

Examples of the ultra-high molecular weight polyolefin include an ultra-high molecular weight ethylene-based polymer, and more specific examples include an ultra-high molecular weight polyethylene. In terms of impact resistance, wear resistance and the like, the viscosity average molecular weight of the ultra-high molecular weight polyolefin may be equal to or greater than 1,000,000, equal to or greater than 2,000,000, or equal to or greater than 3,000,000. Although the upper limit of the viscosity average molecular weight is not particularly limited, in practice, the viscosity average molecular weight may be, for example, equal to or less than 9,000,000, equal to or less than 8,000,000, or equal to or less than 7,000,000.

The innermost layer described previously may include a component other than the material described above as long as the effects of the present invention are not impaired. Examples of the component described above include a pigment, carbon black and the like.

The pipe described above may include a flange fitting in at least one of both end portions of the pipe, and a rough surface may be formed in at least part of an interface between the pipe and the flange fitting. When the pipes described above are connected to each other without being processed with an existing joint such as a cast joint or an iron joint, stress is applied to the pipe at a contact point between the pipe and the joint due to a turbulence or the like produced in the connecting part, with the result that damage or the like of the pipe may be produced. On the other hand, when the pipes are connected to each other, the joint is attached through the flange fitting, and thus it is possible to prevent the production of damage or the like of the pipe resulting from contact between the pipe and the joint. The flange fitting is not particularly limited, and since it is easy to effectively reduce damage or the like of the pipe, a flange fitting which is formed of a material having a coefficient of linear expansion higher than the pipe, for example, a cast flange fitting or an iron flange fitting is preferable.

Although in this way, it is possible to prevent damage or the like of the pipe which can be produced at the contact point between the pipe and the joint, stress is still applied to the interface between the pipe and the flange fitting, with the result that a failure such as damage of the pipe may occur. When the rough surface is formed in at least part of the interface between the pipe and the flange fitting, the rough surface is directed in various directions, and thus the stress applied to the interface is finely dispersed in the various directions. Consequently, the entire stress which is received by the pipe is decreased, and thus damage or the like of the pipe is unlikely to occur.

The rough surface is not particularly limited, and preferably, the rough surface is formed with a screw-processed portion, the screw-processed portion is formed in each of the pipe and the flange fitting and the screw-processed portions engage with each other. When the rough surface is formed with the screw-processed portion, if damage or the like is produced in the pipe or the flange fitting after the pipe having the flange fitting is repeatedly used, the engagement of the screw-processed portions is loosened, the pipe or the flange fitting in which the damage or the like is produced is removed and thus it is possible to easily attach a new pipe or a new flange fitting. The screw-processed portion is not particularly limited, a configuration may be adopted in which a male screw is formed in the pipe and a female thread is formed in the flange fitting or a female thread is formed in the pipe and a male screw is formed in the flange fitting and since damage or the like of the pipe is unlikely to occur, it is preferable to form the male screw in the pipe and the female thread in the flange fitting.

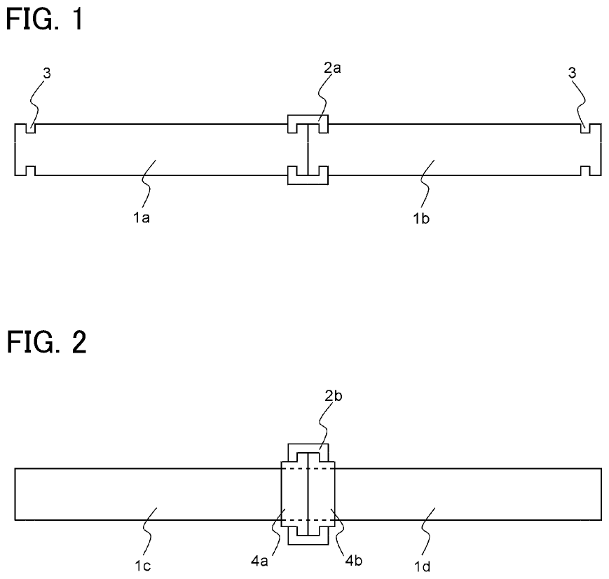

A method of connecting the pipes for transporting a water-containing fluid according to the present invention is not particularly limited. A case where the water-containing fluid is a fresh concrete and the pipe is a pipe for pressure-feeding a fresh concrete will be described below. The method of connecting pipes for pressure-feeding a fresh concrete according to the present invention is not particularly limited, and for example, as shown in FIG. 1, two pipes for pressure-feeding a fresh concrete 1a and 1b can be connected to each other with a joint 2a. Specifically, a cutout portion 3 is previously formed in the vicinity of at least one of end portions of each of the pipes for pressure-feeding a fresh concrete 1a and 1b, the pipes for pressure-feeding a fresh concrete 1a and 1b are brought into close contact with each other at the end portions in the vicinity of which the cutout portions 3 are formed, and then the joint 2a is fitted so as to bridge between the cutout portion 3 in the pipe for pressure-feeding a fresh concrete 1a and the cutout portion 3 in the pipe for pressure-feeding a fresh concrete 1b, with the result that the pipes for pressure-feeding a fresh concrete 1a and 1b can be fixed and connected to each other.

The material of the joint 2a may be the same as that of the pipes for pressure-feeding a fresh concrete 1a and 1b or may be different therefrom. As the joint 2a, a joint which is used in the connecting of conventional pipes for pressure-feeding a fresh concrete and which is made in Japan or in another country may be used without being processed, for example, an existing cast joint or an existing iron joint, and specific examples thereof include a joint made by the Victaulic Company of Japan Limited and the like.

As shown in FIG. 2, two pipes for pressure-feeding a fresh concrete 1c and 1d can be connected to each other with flange fittings 4a and 4b and a joint 2b. Specifically, first, the pipe for pressure-feeding a fresh concrete 1c and the flange fitting 4a are fitted to each other and the pipe for pressure-feeding a fresh concrete 1d and the flange fitting 4b are fitted to each other, then the flange portion of the flange fitting 4a and the flange portion of the flange fitting 4b are brought into close contact with each other, and finally the flange fittings 4a and 4b are fixed together with the joint 2b, with the result that the pipes for pressure-feeding a fresh concrete 1c and 1d can be connected to each other.

A method of fitting the pipe for pressure-feeding a fresh concrete 1c and the flange fitting 4a to each other and a method of fitting the pipe for pressure-feeding a fresh concrete 1d and the flange fitting 4b to each other are not particularly limited. A first example of the method of fitting the pipe for pressure-feeding a fresh concrete 1c and the flange fitting 4a to each other is a method including fixing together the pipe for pressure-feeding a fresh concrete 1c and the flange fitting 4a by engagement of screw-processed portions that are respectively formed in the pipe for pressure-feeding a fresh concrete 1c and the flange fitting 4a so as to engage with each other, in at least part of a region where the pipe for pressure-feeding a fresh concrete 1c and the flange fitting 4a are brought into contact with each other. A second example of the method of fitting the pipe for pressure-feeding a fresh concrete 1c and the flange fitting 4a to each other is a method including fixing together the pipe for pressure-feeding a fresh concrete 1c and the flange fitting 4a in an overlapping part between the pipe for pressure-feeding a fresh concrete 1c and the flange fitting 4a, the fixing being performed by screwing the flange fitting 4a and the pipe for pressure-feeding a fresh concrete 1c together from outside toward inside the pipe for pressure-feeding a fresh concrete 1c in a radial direction or by pinning the flange fitting 4a and the pipe for pressure-feeding a fresh concrete 1c together with a pin inserted through a through hole that is formed to penetrate the flange fitting 4a and the pipe for pressure-feeding a fresh concrete 1c from outside toward inside the pipe for pressure-feeding a fresh concrete 1c in a radial direction. A first example of the method of fitting the pipe for pressure-feeding a fresh concrete 1d and the flange fitting 4b to each other is the same as the first example of the method of fitting the pipe for pressure-feeding a fresh concrete 1c and the flange fitting 4a to each other except that the pipe for pressure-feeding a fresh concrete 1d is used instead of the pipe for pressure-feeding a fresh concrete 1c and that the flange fitting 4b is used instead of the flange fitting 4a. A second example of the method of fitting the pipe for pressure-feeding a fresh concrete 1d and the flange fitting 4b to each other is the same as the second example of the method of fitting the pipe for pressure-feeding a fresh concrete 1c and the flange fitting 4a to each other except that the pipe for pressure-feeding a fresh concrete 1d is used instead of the pipe for pressure-feeding a fresh concrete 1c and that the flange fitting 4b is used instead of the flange fitting 4a.

In order to satisfactorily realize the fitting of the pipe for pressure-feeding a fresh concrete 1c and the flange fitting 4a and the fitting of the pipe for pressure-feeding a fresh concrete 1d and the flange fitting 4b, the material of the flange fittings 4a and 4b is preferably the same as that of the pipes for pressure-feeding a fresh concrete 1c and 1d. The material of the joint 2b may be the same as that of the pipes for pressure-feeding a fresh concrete 1c and 1d or may be different therefrom. As the joint 2b, the joint which is used in the connecting of the conventional pipes for pressure-feeding a fresh concrete may be used without being processed, for example, an existing cast joint as with the joint 2a, and specific examples thereof include a joint made by the Victaulic Company of Japan Limited and the like.

Furthermore, in addition to the methods described above, the pipes can be connected to each other with a mechanical joint.

Although the method of connecting the pipes according to the present invention has been described above, the pipe according to the present invention can be connected to a conventional pipe (for example, a general steel pipe, a conventional pipe for pressure-feeding a fresh concrete using general structural steel or the like, or an iron pipe including a curved pipe, a narrowed pipe or the like), a flexible hose or the like. For example, on the side of the pipe according to the present invention, as described above, the formation of the cutout portion, the fitting to the flange fitting, the fitting of the joint or the like is performed, and on the side of the conventional pipe, the flexible hose or the like, fixing or the like which uses a joint is performed according to a conventional method, with the result that the pipe according to the present invention and the conventional pipe, the flexible hose or the like can be connected to each other.

### <Method of Transporting Water-Containing Fluid>

A method of transporting a water-containing fluid according to the present invention includes a step of transporting the water-containing fluid within the pipe of the present invention. The conditions of the transport and the like are not particularly limited, and may be the same as in a conventional method.

### <Method of Placing Concrete>

A method of placing concrete according to the present invention includes a step of pressure-feeding a fresh concrete within the pipe of the present invention. The fresh concrete, the conditions of pressure feeding and the like are not particularly limited, and may be the same as in a conventional method.

### <Method of Producing Fresh Concrete Set>

A method of producing a fresh concrete set according to the present invention includes a step of pressure-feeding a fresh concrete within the pipe for pressure-feeding a fresh concrete according to the present invention. In the producing method described above, the fresh concrete set includes a series of fresh concretes which are pressure-fed for at least part of a period of time from the start of the pressure feeding until the finish of the pressure feeding. When the fresh concrete is pressure-fed with the conventional pipe using general structural steel or the like, variations in the composition and the quality of the fresh concrete easily occur, and the variations tend to be increased as the pressure feeding proceeds, with the result that variations in composition and quality between the fresh concrete which is previously pressure-fed and the fresh concrete which is later pressure-fed also easily occur. By contrast, when the fresh concrete is pressure-fed within the pipe for pressure-feeding a fresh concrete according to the present invention, variations in the composition and the quality of the fresh concrete are unlikely to occur. Hence, variations in composition and quality between a series of fresh concretes in the fresh concrete set obtained by the producing method described above and the fresh concrete after being prepared and before being pressure-fed are unlikely to occur. In comparison of a series of the fresh concretes, variations in composition and quality between the fresh concrete which is previously pressure-fed and the fresh concrete which is later pressure-fed are also unlikely to occur.

### EXAMPLES

Although the present invention will be more specifically described below using the Examples, the scope of the present invention is not limited to the Examples. The following experiments were performed in Kawabata Kogyo Corporation with devices and other appliances of Kawabata Kogyo Corporation.

### Example 11

As shown in FIG. 1, with joints (conventional cast joints), 20 black pipes (having an outside diameter of 125 mm, an inside diameter of 102.2 mm and a length of 3 or 2 m) made of a PE100 grade high density polyethylene (specifically, 10 pipes having a length of 3 m and 10 pipes having a length of 2 m) were connected together, and thus a pipeline of the pipes for pressure-feeding a fresh concrete was produced. The details of the high density polyethylene are as follows.

Water absorption rate: <0.01% by mass
Thermal conductivity: 0.5 W/m·K
Density: 0.950 g/cm³
Notched Izod impact strength: 200 J/m
Volume wear rate: 80 when the volume wear rate of SS400 is set to 100
Dynamic friction coefficient: 0.2
Viscosity average molecular weight: 4×10⁵

### Example 2

Four black pipes (having an outside diameter of 114.0 mm, an inside diameter of 94.0 mm and a length of 3 m) made of an ultra-high molecular weight polyethylene were connected together with mechanical joints, and thus a pipeline of the pipe for pressure-feeding a fresh concrete was produced. The details of the ultra-high molecular weight polyethylene are as follows.

Water absorption rate: <0.01% by mass
Thermal conductivity: 0.4 W/m·K
Density: 0.94 g/cm³
Notched Izod impact strength: not destroyed
Volume wear rate: 15 when the volume wear rate of SS400 is set to 100
Dynamic friction coefficient: 0.2
Viscosity average molecular weight: 5 million

### Comparative Example 1

Thirty-one steel pipes having a length of 3 m and an inside diameter of about 107 mm were connected together with flexible synthetic rubber hoses (total length of 7 m), and thus a pipeline of the pipes for pressure-feeding a fresh concrete was produced. The details of the materials of the steel pipes described above are as follows.

Water absorption rate: 0.35% by mass
Thermal conductivity: 84 W/m·K
Density: 7.87 g/cm³
Impact resistance: plastic deformation
Volume wear rate: 100 when the volume wear rate of SS400 is set to 100
Dynamic friction coefficient: 0.47

### [Concrete Pressure-Feeding Test 1: Examples 1 and 2 and Comparative Example 1]

With the pipeline of the pipes produced in Examples or Comparative Example, the pressure-feeding speed was set to 10 m³/h or the revolutions of an accelerator was set to 1000 and the amount of pump discharge was set to the lowest amount, and fresh concrete was pressure-fed. At that time, as a concrete inducer, 18 L of a preceding mortar was used in Examples, and 18 L of the preceding mortar was used in Comparative Example. When the pipes of Example 1 or 2 were used, the fresh concrete was pressure-fed without being blocked. At that time, it was visually confirmed that the fresh concrete discharged from a pipe outlet maintained high fluidity. On the other hand, when the pipe of Comparative Example 1 was used, the fresh concrete was blocked in a position 48 m away from a pipe inlet.

### (Considerations)

As described above, in Example 1, 18 L of the preceding mortar was used so as to achieve a pressure-feeding distance of at least 50 m. On the other hand, in Comparative Example 1, 18 L of the preceding mortar was used so as to achieve only a pressure-feeding distance of 48 m. In other words, when the pipe for pressure-feeding a fresh concrete according to the present invention was used to pressure-feed the fresh concrete, the same amount of concrete inducer such as the preceding mortar was used so as to achieve a pressure-feeding distance exceeding a conventional pressure-feeding distance. Here, it is clear that, when the pipe for pressure-feeding a fresh concrete according to the present invention is used, the pressure-feeding distance is decreased as the amount of the concrete inducer is reduced, but when the amount is equal to or greater than a constant amount, it is possible to achieve a pressure-feeding distance equivalent to or greater than the conventional pressure-feeding distance. Hence, it is possible to reasonably conclude that, when the pipe for pressure-feeding a fresh concrete according to the present invention is used to pressure-feed the fresh concrete, a pressure-feeding distance equivalent to or greater than the conventional pressure-feeding distance can be achieved even if the amount of concrete inducer such as the preceding mortar is reduced.

In Example 2, instead of the black pipes made of the ultra-high molecular weight polyethylene, milky white, gray, or light yellow pipes made of the ultra-high molecular weight polyethylene can be used to produce a pipe for pressure-feeding a fresh concrete. The milky white, gray or light yellow pipe for pressure-feeding a fresh concrete produced as described above transmits light, and thus the way in which the pipe is seen can be changed by whether or not the fresh concrete is present in the pipe. Hence, unlike the conventional pipe for pressure-feeding a fresh concrete using the steel pipes, it is possible to easily and visually check whether or not the fresh concrete is present in the pipe and whether or not the fresh concrete is being moved in the pipe. Conventionally, the presence of fresh concrete in a pipe is checked with hitting sound produced when a steel pipe is hit with a hammer or the like. On the other hand, when the milky white, gray, or light yellow pipe for pressure-feeding a fresh concrete is used, the presence thereof can be visually checked, with the result that the hitting operation using a hammer or the like is not needed and that safety is thus easily enhanced.

### [Concrete Pressure-Feeding Test 2: Example 4]

A continuous pressure-feeding durability test was performed in the same manner as in Example 1 except that a simulated fresh concrete obtained by replacing cement in the fresh concrete with slaked lime was used and continued to be pressure-fed instead of the fresh concrete in Example 1. The simulated fresh concrete is not solidified unlike a fresh concrete. In the result of the test described above, the pipe for pressure-feeding a fresh concrete according to the present invention was worn as time passed, and when the pressure-feeding amount exceeded 7000 m³, a hole was made.

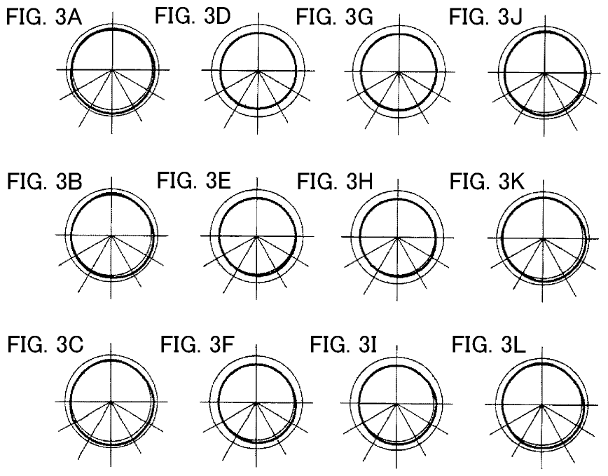

In order to verify the process in which the pressure-feeding pipe described above was worn, the cross-sectional shapes of the pipe were observed, on an arbitrary pipe having a length of 3 m in the pressure-feeding pipe, at four parts, that is, in the vicinity of an inlet, a part 1 m away from the inlet, a part 2 m away from the inlet and in the vicinity of an outlet when the pressure-feeding amount reached 4000 m³, 5000 m³, and 6000 m³. The results of observations of the process in which the pipe for pressure-feeding a fresh concrete according to the present invention was worn in the continuous pressure-feeding durability test are shown in FIGS. 3A to 3L. FIGS. 3A to 3C show the result of the observation of the vicinity of the inlet. FIGS. 3D to 3F show the result of the observation of the part 1 m away from the inlet. FIGS. 3G to 31 show the result of the observation of the part 2 m away from the inlet. FIGS. 3J to 3L show the result of the observation of the vicinity of the outlet. The upper row of FIGS. 3A to 3L shows the result of the observation when the pressure-feeding amount reached 4000 m³. The middle row of FIGS. 3A to 3L shows the result of the observation when the pressure-feeding amount reached 5000 m³. The lower row of FIGS. 3A to 3L shows the result of the observation when the pressure-feeding amount reached 6000 m³. In FIGS. 3A to 3L, a thin curve indicates a cross section of the pressure-feeding pipe before being pressure-fed, and a thick curve indicates the inner surface at the time of the observation after the start of the pressure feeding. In FIGS. 3A to 3L, an upper side applies to an upper side in a vertical direction, and a lower side applies to a lower side in the vertical direction. In other words, in FIGS. 3A to 3L, gravity acts from the upper side to the lower side.

It is found from the results shown in FIGS. 3A to 3L that severe wear occurred in the vicinity of the inlet and in the vicinity of the outlet and that almost no wear was observed or a very small amount of wear occurred around an intermediate point between the inlet and the outlet. In the vicinity of the inlet and in the vicinity of the outlet, it is likely that severe wear occurred for some reason, for example, because any backlash occurred in the connecting part of the pipes, thereby causing a turbulence in a fluid formed of the simulated fresh concrete. In FIGS. 3A to 3L, a tendency in which more severe wear occurred on the lower side is observed. It is estimated that this was caused by the fact that, in the simulated fresh concrete being pressure-fed, a larger amount of aggregate was present on the lower side by the influence of gravity.

### [Concrete Pressure-Feeding Test 3: Example 5 and Comparative Example 2]

A pipeline of the pipes for pressure-feeding a fresh concrete was produced in the same manner as in Example 1 except that, in Example 1, 10 black pipes described above having a length of 2 m were used (Example 5). On the other hand, a pipeline of the pipes for pressure-feeding a fresh concrete was produced in the same manner as in Comparative Example 1 except that, in Comparative Example 1, the length of the steel pipe was changed from 3 m to 2 m and that 10 steel pipes described above were used (Comparative Example 2). With the pipeline of the pipes produced in Example 5 or Comparative Example 2, the simulated fresh concrete used in Example 4 was pressure-fed at a pressure-feeding speed set to 10, 20, or 30 m³/h. At that time, a small piece of sponge was put in from the pipe inlet, and thus a time (pressure-feeding time) until it was discharged from the pipe outlet was measured. With a pressure gauge attached to the pipe, the maximum pressure at the time of pressure feeding was measured. The results are shown in Table 1.

TABLE 1

| | | | |
|---|---|---|---|
| Pressure-feeding speed (m³/h) | 10 | 20 | 30 |

| | | | | |
|---|---|---|---|---|
| Example 5 | Pressure-feeding time | 89 | 41 | 24 |
| | (second) | | | |
| | Maximum pressure | 5.0 | 7.0 | 8.4 |
| | (MPa) | | | |
| Comparative | Pressure-feeding time | 104 | 49 | 29 |
| Example 2 | (second) | | | |
| | Maximum pressure | 5.5 | 7.5 | 9.0 |
| | (MPa) | | | |

As is found from Table 1, even when any one of the pressure-feeding speeds was used, the pressure-feeding time was short and the maximum pressure at the time of pressure feeding was low in Example 5, as compared with Comparative Example 2. Hence, it has been confirmed that, when the pipe for pressure-feeding a fresh concrete according to the present invention is used to pressure-feed the fresh concrete, the fresh concrete can be pressure-fed with a lower pressure at a higher speed than before and that the property of pressure feeding is enhanced.

### [Concrete Pressure-Feeding Test 4: Example 6 and Comparative Example 3]

With the pipeline of the pipes produced in Example 5 or Comparative Example 2, the fresh concrete (nominal strength of 24 N/mm², slump of 15 cm, aggregate particle diameter of 20 mm) was pressure-fed at a pressure-feeding speed set to 10 m³/h. The time from the start of the pressure feeding until the finish of the pressure feeding was divided into four equal phases, and they were referred to as the first to fourth phases in time order. The fresh concrete before being pressure-fed, the fresh concrete which finished being pressure-fed and was discharged from the pipe at an intermediate point of the second phase, and the fresh concrete which finished being pressure-fed and was discharged from the pipe at an intermediate point of the third phase were collected, and a composition test and a quality test below were performed thereon.

### (Composition Test)

The fresh concrete was sieved, the residue on the sieve was classified and washed, an aggregate was collected, and the mass of the aggregate was measured. The mass of the aggregate per unit volume of the fresh concrete after being pressure-fed (hereinafter referred to as the “aggregate mass after being pressure-fed”) was measured, was compared with the mass of the aggregate per unit volume of the fresh concrete before being pressure-fed (hereinafter referred to as the “aggregate mass before being pressure-fed”) and was evaluated with criteria below. The results are shown in Table 2.

∘ (satisfactory): The aggregate mass after being pressure-fed is equal to or greater than 90% by mass and equal to or less than 110% by mass of the aggregate mass before being pressure-fed.
x (failure): The aggregate mass after being pressure-fed is less than 90% by mass or greater than 110% by mass of the aggregate mass before being pressure-fed.

### (Quality Test)

The strength of the fresh concrete after one week and the strength of the fresh concrete after four weeks were measured according to JIS A 1108, and were evaluated with criteria below. The results are shown in Table 2.

⋅ Strength after one week
∘ (satisfactory): The strength after one week is equal to or greater than 16 N/mm².
x (failure): The strength after one week is less than 16 N/mm².
⋅ Strength after four weeks
∘ (satisfactory): The strength after four weeks is equal to or greater than 24 N/mm².
x (failure): The strength after four weeks is less than 24 N/mm².

TABLE 2

| | | Intermediate point | Intermediate point |
|---|---|---|---|
| | | of second phase | of third phase |
| Example 6 | Composition | ∘ | ∘ |
| | test | | |
| | Strength after | ∘ | ∘ |
| | one week | | |
| | Strength after | ∘ | ∘ |
| | four weeks | | |
| Comparative | Composition | x | x |
| Example 3 | test | | |
| | Strength after | x | x |
| | one week | | |
| | Strength after | x | x |
| | four weeks | | |

As is found from Table 2, in Example 6, as compared with Comparative Example 3, the results of the composition test, the strength after one week, and the strength after four weeks were satisfactory. Hence, it has been confirmed that, when the fresh concrete is pressure-fed within the pipe for pressure-feeding a fresh concrete according to the present invention, variations in the composition and the quality of the fresh concrete are unlikely to occur.

### [Evaluation 1 of Pipes Having Flange Fittings: Example 7]

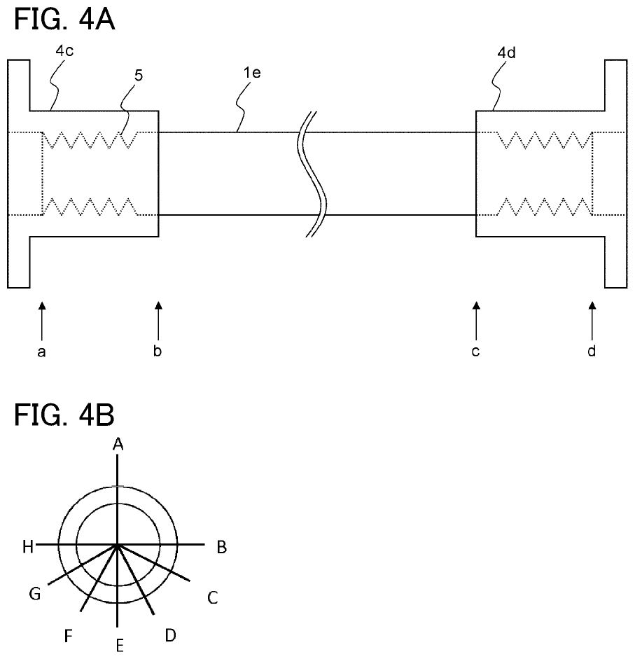

As shown in FIG. 4A, flange fittings 4c and 4d were attached through screw-processed portions 5 to both end portions of the black pipe (pipe wall thickness: 7.4 mm) used in Example 1 and having a length of 3 m. The length of the screw-processed portion 5 in a pipe longitudinal direction was 20 mm Ten black pipes having the flange fittings 4c and 4d were connected with joints (conventional cast joints) so as to produce the pipeline of a pipe for pressure-feeding a fresh concrete 1e. With the pipeline, the simulated fresh concrete used in Example 4 was continuously pressure-fed at a pressure-feeding speed set to 10 m³/h, and a continuous pressure-feeding durability test was thus performed.

The pipe wall thicknesses of the first, the third, the fifth, the seventh, and the tenth pipes in the pressure-feeding pipe were measured at four parts, that is, in the vicinity of the pipe inlet (a in FIG. 4A), around an end portion on the downstream side of the flange fitting on the inlet side (b in FIG. 4A), around an end portion on the upstream side of the flange fitting on the outlet side (c in FIG. 4A), and in the vicinity of the pipe outlet (d in FIG. 4A) when the pressure-feeding amount reached 5000 m³. The results are shown in Table 3 (unit: mm). Here, a to d in Table 3 are the same as those in FIG. 4A. A to H in Table 3 indicate the measurement positions of the pipe wall thickness, and are the same as those in FIG. 4B. In FIG. 4B, A applies to an upper side in a vertical direction, E applies to a lower side in the vertical direction, B applies to a right side in a horizontal direction with respect to the pressure-feeding direction of the fresh concrete and H applies to a left side in the horizontal direction with respect to the pressure-feeding direction of the fresh concrete.

TABLE 3

| First pipe | | | | | Third pipe | | | | |
|---|---|---|---|---|---|---|---|---|---|
| | a | b | c | d | | a | b | c | d |
| A | 7.17 | 7.37 | 7.15 | 7.18 | A | 7.28 | 7.65 | 7.47 | 6.88 |
| B | 6.91 | 6.25 | 5.82 | 6.85 | B | 6.66 | 5.86 | 5.61 | 6.88 |
| C | 7.00 | 6.02 | 5.00 | 6.89 | C | 6.75 | 5.38 | 4.62 | 6.80 |
| D | 7.22 | 6.14 | 4.32 | 6.67 | D | 6.43 | 5.45 | 4.25 | 6.76 |
| E | 6.97 | 6.20 | 3.78 | 6.60 | E | 6.95 | 5.80 | 3.76 | 7.11 |
| F | 7.00 | 7.40 | 3.61 | 6.97 | F | 6.93 | 6.45 | 4.08 | 7.00 |
| G | 7.19 | 6.98 | 4.29 | 7.08 | G | 7.24 | 5.98 | 4.83 | 6.84 |
| H | 7.00 | 6.80 | 5.61 | 6.94 | H | 7.65 | 7.76 | 5.51 | 6.76 |
| Fifth pipe | | | | | Seventh pipe | | | | |
| | a | b | c | d | | a | b | c | d |
| A | 7.25 | 7.70 | 6.90 | 6.96 | A | 7.47 | 7.22 | 7.39 | 6.98 |
| B | 6.65 | 6.90 | 6.98 | 7.15 | B | 6.75 | 6.35 | 6.06 | 6.92 |
| C | 6.91 | 5.55 | 5.72 | 7.21 | C | 6.54 | 6.22 | 5.51 | 6.94 |
| D | 6.90 | 5.98 | 4.57 | 6.90 | D | 6.46 | 6.02 | 4.06 | 6.48 |
| E | 6.80 | 5.70 | 3.81 | 6.85 | E | 6.34 | 5.92 | 4.00 | 6.80 |
| F | 6.77 | 6.06 | 3.88 | 7.25 | F | 6.61 | 6.51 | 4.62 | 6.60 |
| G | 7.10 | 6.40 | 4.57 | 6.91 | G | 6.66 | 6.63 | 5.80 | 6.84 |
| H | 7.13 | 6.70 | 5.06 | 7.00 | H | 7.24 | 7.10 | 7.06 | 7.25 |

Tenth pipe

| | a | b | c | d |
|---|---|---|---|---|
| A | 6.95 | 7.88 | 7.65 | 7.19 |
| B | 7.33 | 6.55 | 6.45 | 7.23 |
| C | 7.23 | 6.25 | 5.45 | 6.86 |
| D | 6.91 | 5.72 | 4.66 | 6.55 |
| E | 7.03 | 6.32 | 3.85 | 6.54 |
| F | 6.99 | 6.04 | 3.88 | 6.39 |
| G | 6.93 | 6.13 | 4.33 | 6.70 |
| H | 6.93 | 6.47 | 5.70 | 7.10 |

As is found from Table 3, severe wear occurred around the end portion on the downstream side of the flange fitting on the inlet side (b in FIG. 4A) and around the end portion on the upstream side of the flange fitting on the outlet side (c in FIG. 4A), and in particular, wear in the latter was significant.

### [Evaluation 2 of Pipes Having Flange Fittings: Examples 8 to 10]

The length of the screw-processed portion in the pipe longitudinal direction was set to 20, 30 or 40 mm, and the pipeline of the pipes for pressure-feeding a fresh concrete similar to Example 7 were produced (the length described above was 20 mm in Example 8, the length described above was 30 mm in Example 9, and the length described above was 40 mm in Example 10). The outlet of the pipe was covered with a lid so as to be intentionally blocked, and the simulated fresh concrete was pressure-fed. When the pressure feeding was performed at the standard pressure of a pump, the screw threads came off and the flange fittings were blown off in Examples 8 and 9, but no damage occurred in the pipe or the flange fittings in Example 10. When the pump pressure was switched to a high pressure, and the pressure feeding was performed in the same manner, not the flange fittings but the pipe ruptured. It is found from these results that, as the length of the screw-processed portion in the pipe longitudinal direction is increased, the durability of the flange fitting is enhanced. It is found that, when the length described above reaches 40 mm, the durability of the flange fitting exceeds the durability of the pipe, and thus the durability of the flange fitting is sufficiently obtained.

### EXPLANATION OF REFERENCE NUMERALS

1a to 1e Pipe for pressure-feeding a fresh concrete
2a, 2b Joint
3 Cutout portion
4a to 4d Flange fitting
5 Screw-processed portion

1-19. (canceled)

20. A method of producing a fresh concrete set, the method comprising: pressure-feeding fresh concrete within a pipe for pressure-feeding fresh concrete, wherein
the fresh concrete set includes a series of fresh concretes which are pressure-fed for at least part of a period of time from start of the pressure feeding until finish of the pressure feeding;
the pipe comprises an innermost layer formed on at least an inner surface of the pipe, the innermost layer including a material that has a water absorption rate of equal to or less than 0.2% by mass and a thermal conductivity of equal to or less than 10 W/m·K;
a time from the start of the pressure feeding until the finish of the pressure feeding is divided into four equal phases, and the phases are referred to as first to fourth phases in time order;
a fresh concrete which finishes being pressure-fed and is discharged from the pipe at an intermediate point of the second phase is referred to as a fresh concrete at the intermediate point of the second phase;
a fresh concrete which finished being pressure-fed and is discharged from the pipe at an intermediate point of the third phase is referred to as a fresh concrete at the intermediate point of the third phase;
a mass of an aggregate per unit volume of the fresh concrete at the intermediate point of the second phase is equal to or greater than 90% by mass and equal to or less than 110% by mass of a mass of an aggregate per unit volume of a fresh concrete before being pressure-fed;
a mass of an aggregate per unit volume of the fresh concrete at the intermediate point of the third phase is equal to or greater than 90% by mass and equal to or less than 110% by mass of a mass of an aggregate per unit volume of a fresh concrete before being pressure-fed; and
the fresh concrete at the intermediate point of the second phase and the fresh concrete at the intermediate point of the third phase have a strength after one week measured according to JIS A 1108 of equal to or greater than 16 N/mm², or the fresh concrete at the intermediate point of the second phase and the fresh concrete at the intermediate point of the third phase have a strength after four weeks measured according to JIS A 1108 of equal to or greater than 24 N/mm².

21. The method of producing according to claim 20, wherein the material has a notched Izod impact strength of equal to or greater than 100 J/m.

22. The method of producing a fresh concrete set according to claim 20, wherein the material has a volume wear rate of equal to or less than 85 when a volume wear rate of SS400 is set to 100.

23. The method of producing a fresh concrete set according to claim 20, wherein the material has a dynamic friction coefficient of equal to or less than 0.3.

24. The method of producing a fresh concrete set according to claim 20, wherein the material is a high density polyolefin having a viscosity average molecular weight of less than 1,000,000.

25. The method of producing a fresh concrete set according to claim 24, wherein the high density polyolefin is a high density ethylene-based polymer.

26. The method of producing a fresh concrete set according to claim 20, wherein the material is an ultra-high molecular weight polyolefin having a viscosity average molecular weight of equal to or greater than 1,000,000.

27. The method of producing a fresh concrete set according to claim 26, wherein the ultra-high molecular weight polyolefin is an ultra-high molecular weight ethylene-based polymer.

28. The method of producing a fresh concrete set according to claim 20, wherein the pipe includes a flange fitting in at least one of both end portions of the pipe, and a rough surface is formed in at least part of an interface between the pipe and the flange fitting.

29. The method of producing a fresh concrete set according to claim 28, wherein the rough surface is formed with a screw-processed portion, and the screw-processed portion is formed in each of the pipe and the flange fitting and the screw-processed portions engage with each other.

30. The method of producing a fresh concrete set according to claim 20, wherein the at least part of a period of time from start of the pressure feeding until finish of the pressure feeding is a combination of the second phase and the third phase.

31. A method of suppressing variations in a composition and a quality between
a series of fresh concretes in a fresh concrete set obtained by a method of producing a fresh concrete set and
a fresh concrete after being prepared and before being pressure-fed,
the method of producing comprising: pressure-feeding fresh concrete within a pipe for pressure-feeding fresh concrete, wherein
the fresh concrete set includes a series of fresh concretes which are pressure-fed for at least part of a period of time from start of the pressure feeding until finish of the pressure feeding; and
the pipe comprises an innermost layer formed on at least an inner surface of the pipe, the innermost layer including a material that has a water absorption rate of equal to or less than 0.2% by mass and a thermal conductivity of equal to or less than 10 W/m·K.

32. A method of suppressing variations in a composition and a quality between a fresh concrete which is previously pressure-fed and a fresh concrete which is later pressure-fed in a series of fresh concretes in a fresh concrete set obtained by a method of producing a fresh concrete set,
the method of producing comprising: pressure-feeding fresh concrete within a pipe for pressure-feeding fresh concrete, wherein
the fresh concrete set includes a series of fresh concretes which are pressure-fed for at least part of a period of time from start of the pressure feeding until finish of the pressure feeding; and
the pipe comprises an innermost layer formed on at least an inner surface of the pipe, the innermost layer including a material that has a water absorption rate of equal to or less than 0.2% by mass and a thermal conductivity of equal to or less than 10 W/m·K.

33. The method according to claim 32, wherein the material has a notched Izod impact strength of equal to or greater than 100 J/m.

34. The method according to claim 32, wherein the material has a volume wear rate of equal to or less than 85 when a volume wear rate of SS400 is set to 100.

35. The method according to claim 32, wherein the material has a dynamic friction coefficient of equal to or less than 0.3.

36. The method according to claim 32, wherein the material is a high density polyolefin having a viscosity average molecular weight of less than 1,000,000.

37. The method according to claim 36, wherein the high density polyolefin is a high density ethylene-based polymer.

38. The method according to claim 32, wherein the material is an ultra-high molecular weight polyolefin having a viscosity average molecular weight of equal to or greater than 1,000,000.

39. The method according to claim 38, wherein the ultra-high molecular weight polyolefin is an ultra-high molecular weight ethylene-based polymer.
